(19) United States
(12) Patent Application Publication
(10) Pub. No.: US 2004/0198425 A1
(43) Pub. Date: Oct. 7, 2004

(54) Establishing half-duplex audio link as battery saving means

(76) Inventors: Charles M. Mellone, Boynton Beach, FL (US); Shafer Burch Seymour, Bartlett, IL (US)

Correspondence Address: Barbara R. Doutre, Motorola, Inc., Law Department, 8000 West Sunrise Boulevard, Fort Lauderdale, FL, 33322, US

(21) Appl. No.: 10/261,871

(22) Filed: Oct. 1, 2002

(51) Int. Cl. H04Q 7/20; H04B 1/38

(52) U.S. Cl. 455/553.1; 455/574; 455/517; 455/68; 455/67.11

(57) ABSTRACT

A communication system (100) includes a first communication device (102) having full-duplex and half-duplex capability and a second communication device (104) having half-duplex capability. The second communication device (104) recognizes that the first communication device supports a half-duplex mode of operation and automatically establishes a half-duplex audio link (116) in response thereto. System (100) provides battery savings to the devices within the system that would otherwise default into a full-duplex mode of operation.

### FIELD OF THE INVENTION

This invention relates generally to personal area networking systems and more specifically to power saving techniques to extend battery life in products within such systems.

### BACKGROUND OF THE INVENTION

Conserving battery power has always been a critical factor when designing portable electronic products. As communication systems move into the wireless realm battery saving continues to be an important aspect of portable product design.

Short-range wireless communication systems, such as Bluetooth® systems, are increasing in popularity. Bluetooth is a low-power, short-range wireless networking standard designed for local area voice and data communications. Bluetooth is specifically suited to portable battery operated devices. The communication devices of these systems typically form an ad hoc wireless network when within communication range of one another. One communication device assumes the role of master and temporarily manages and synchronizes the other communication devices in the ad hoc wireless network. Mobile computers, mobile phones and headsets, personal data assistants (PDAs) and personal computers (PCs), can all exchange information using the Bluetooth specification.

As the portable wireless marketplace continues to expand, market requirements demand products that are ever smaller in form factor, more cost effective, and which incorporate value-added features, such as improved battery life. Currently a full-duplex operating mode is used when a voice link is established between a Bluetooth device and a second communication device, referred to as the audio gateway (AG) device. Full-duplex communication provides simultaneous two-way communication, such as used in cell phones. However, Bluetooth devices can operate with a variety of communication devices, some of which may not require full-duplex capability, for example two-way (half-duplex) radios. As a result of the full-duplex mode of operation, battery life suffers.

Accordingly, it would be desirable to improve battery life in portable wireless product applications, such as Bluetooth applications as well as others.

### BRIEF DESCRIPTION OF THE DRAWINGS

The present invention is illustrated by way of example and not limitation in the accompanying figures, in which like references indicate similar elements, and in which:

FIG. 1 is a system diagram of a communication system operating in accordance with the present invention;

FIG. 2 is a block diagram showing an example of an implementation of the remote communication device of FIG. 1;

FIG. 3 is a flow chart of a first method for switching from full-duplex to half-duplex audio in accordance with the invention; and

FIG. 4 is a flow chart of an alternative method for switching from full-duplex to half-duplex in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

As mentioned previously, in conditions where half-duplex communication is all that is needed, the use of full-duplex drains batteries unnecessarily. Referring to FIG. 1, there is shown a communication system that provides improved battery life by dynamically managing full-duplex and half-duplex capabilities. Communication system 100 includes first and second communication devices 102, 104 respectively operating in accordance with the present invention. The first communication device 102 is a remote device that has a default full-duplex mode of operation, and in accordance with the present invention, further includes half-duplex capability. In accordance with the present invention, the second communication device 104 detects whether the first communication device 102 supports a half-duplex mode of operation. Once half-duplex capability is detected, the first communication device 102 switches over to a half-duplex mode of operation in order to conserve battery life. To bring about this capability, the second communication device 104 includes an interrogation type capability available through such specifications as Bluetooth Service Discovery Protocol (SDP), Service Location Protocol (SLP), Jini and Salutation protocols to name a few. In accordance with the present invention, the second communication device 104 detects whether the first communication device 102 supports half-duplex capability using the interrogation protocol. When the second communication device 104 has determined that half-duplex capability is available, then a half-duplex audio link is established through the use of control messages that selectively enable/disable audio over the existing channel in both directions between the two devices. Communication system 100 communicates with other half-duplex devices 106. Thus, a user might wear an earpiece 102 about the ear, a two-way radio 104 on the belt and communicate with device 106. Using the half-duplex audio link preserves battery life in all devices within the system, particularly the earpiece which is likely to be the smallest, lightest and most constrained device within the system.

The preferred embodiment of the invention will be described in terms of a Bluetooth system, however the battery savings achieved with the apparatus and techniques described herein can also be applied to other communication protocols as well. Referring again to FIG. 1, the second communication device 104 recognizes that the first communication device 102 has half-duplex capability and automatically establishes a half-duplex audio link in response thereto. The earpiece 102 includes a push-to-talk (PTT) button 108, a microphone 112, and a speaker 114. The second communication device 104 is a half-duplex audio device, such as a two-way radio. In the Bluetooth environment, the two-way radio 104 provides the audio gateway (AG) and operates as the controller or link master to the earpiece 102 operating as the slave. Two-way radio 104 includes a radio Bluetooth adapter (RBA) that allows for a wireless link to be established between the two devices 102, 104. Control messages are sent between devices 102, 104 over a Bluetooth asynchronous communications link (ACL) link 116 to selectively enable/disable audio over an existing synchronous connection oriented (SCO) channel in both directions. The SCO channel is used for transmission of digital audio information. The control method extends AT (ATtention) command codes already defined for the Bluetooth headset profile to include microphone and speaker on/off commands. The earpiece 102 can thus function in a public safety mode in conjunction with two-way radio 104.

The public safety mode, or PTT feature, causes the earpiece 102 to act like a traditional two-way radio. The audio path from the two-way radio 104 to the earpiece 102 is established and always sending a signal 118. The return path 120, from earpiece 102 to the two-way radio 104 will only be active when the user requests transmission by depressing the PTT button 108. The earpiece further includes a Bluetooth (BT) button 110 for full-duplex call origination/termination. The public safety half-duplex mode is detectable by service discovery protocol (SDP) software controlled by the two-way radio 104. In accordance with the present invention, button press and release events from earpiece 102 are reported to the two-way radio 104, and the two-way radio 104 sends commands to the earpiece 102 to turn the audio on or off.

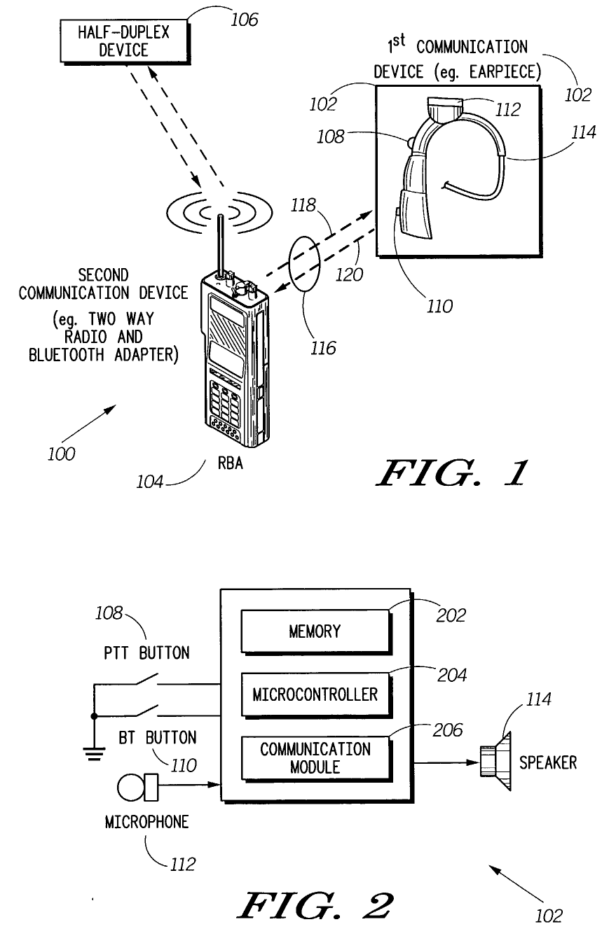

Referring to FIG. 2, there is shown a preferred general block diagram for the first communication device 102 of FIG. 1. The first communication device 102 includes the speaker 114, microphone 112 and PTT button 108. First communication device 102 further includes a memory 202, a micro-controller 204, and a communications module 206. In accordance with the present invention, communications module 206 is responsive to interrogations and commands directed to it from the second communication device 104 of FIG. 1. The interrogation capabilities in the Bluetooth embodiment are provided by the service discovery protocol (SDP) software controlled by the second communication device 104. The communications module also includes audio converters, filters, and transceiver circuitry. Other configurations can also be envisioned.

In accordance with the present invention, the first communication device 102 operates in both full-duplex and half-duplex modes. In accordance with the present invention, when the first communication device 102 establishes a link with a half-duplex device, that half-duplex device enables the half-duplex capability. The half-duplex capability is controlled by commands being transmitted between the two devices. For example, the two-way radio 104 can control the audio channel with the earpiece 102. When connected to a half-duplex audio device, audio needs to flow in only one direction at a time. Thus, the two-way radio 104 sends a command, in response to a trigger, such as a PTT press that enables the microphone and audio link from the earpiece 102 to the two-way radio 104. When the PTT 108 is released, a separate command is sent from the two-way 104 to the earpiece 102 that turn off that link. Proper control of the half-duplex capability, and the uplink audio channel, extends the battery life to all devices within the system. In addition to the two-way radio market, the half-duplex operating capability can be used by any communication device having half-duplex capability, such as an iDEN® phone manufactured by Motorola, Inc.

In an alternative embodiment, the third communication device 106 can also provide a remote trigger (for example PTT or voice activated switch VOX) operation. In this case the third communication device 106 detects a PTT or VOX input and then sends a notification (a command ) to the second communication device 104 which then issues the command to put the first communication device into half-duplex mode of operation.

Communication system 100 preferably utilizes one of two methods described below. One method uses two commands in which a first command turns the microphone on and the speaker off while the second command turns the speaker on and the microphone off. Alternatively, four commands can be used to turn of the microphone on and off separately and turn the speaker on and off using separate commands. As mentioned previously, in the Bluetooth embodiment the commands would be AT commands.

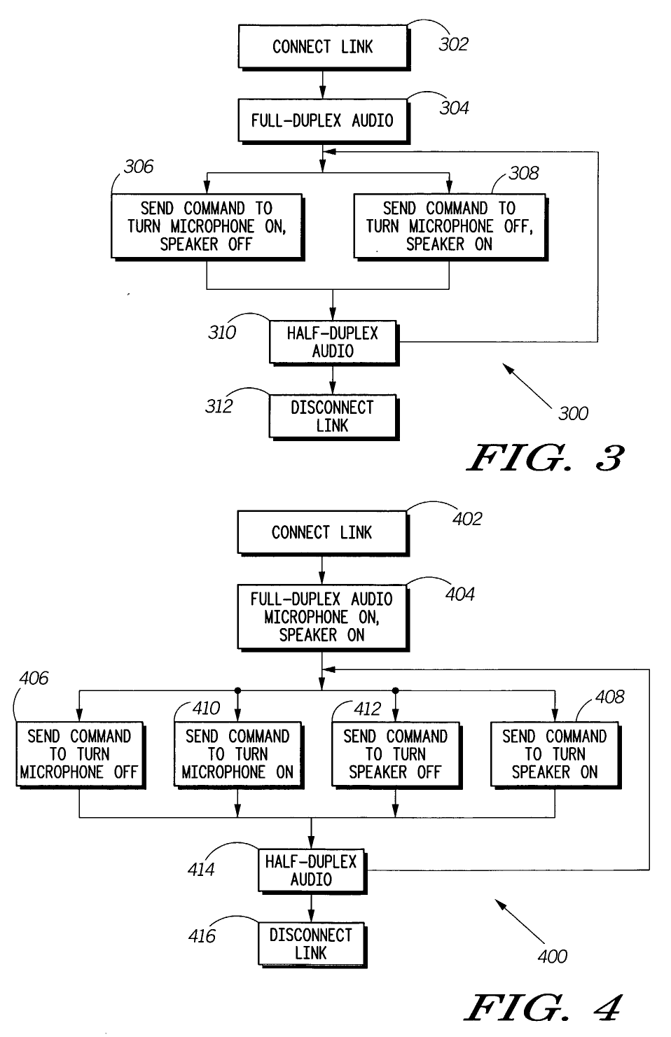

Referring to FIG. 3, there is shown a flow chart of a sequence of steps for controlling the audio link between the first and second communication devices 102, 104. First, a communication link is established at step 302 between a first communication device, a remote device having full and half-duplex capability, and a second communication device, having half-duplex capability. Full-duplex audio is initially established between the two devices at step 304. The second communication device (e.g. two-way radio) uses its interrogation capabilities to query the first communication device (e.g. earpiece) to detect whether the first communication device supports half-duplex operation. Once half-duplex capability is determined, the first communication device switches over to its half-duplex mode of operation. A command is generated, such as through a PTT press or a VOX signal at the first communication device 102. In response thereto, the second communication device 104 sends a command to turn the microphone on and the speaker off at step 306. Another command, such as through a PTT release or lack of VOX signal, is sent from the first communication device at step 308 which tells the second communication device to turn the microphone off and the speaker on. Half-duplex audio is thus established at step 310 and the audio link continues in the half-duplex fashion at step 310, 306, 308 until the link is disconnected at step 312.

Referring to FIG. 4, there is shown an alternative sequence of steps 400 for controlling the audio link between first and second communication devices 102, 104 of FIG. 1 in accordance with the invention. First, a communication link is established at step 402 between the first communication device and the second communication device. Full-duplex audio is initially established between the two devices at step 404 with both the microphone and speaker of the remote device being turned on. The interrogation capability of the second communication device allows it to recognize that the first communication device has half-duplex capability. User initiated commands are sent from the first communication device 102 to the second communication device 104 in response to a PTT button being pressed or a VOX signal being received at the microphone. Audio will only be enabled at the first communication device 102 when commanded to do so by the second communication device 104. The microphone is thus turned on at step 410 and the speaker turned off at step 412 so that audio can be sent from the first communication to the second communication device. When the user initiated PTT is released or a lack of VOX signal is detected at the first communication device then a command is sent from the second communication device to turn the microphone off and the speaker on at steps 406, 408. Half-duplex audio is thus established at step 414 and the audio link continues in the half-duplex fashion at step using steps 406, 408, 410, and 412 until the link is disconnected at step 416.

The techniques 300, 400 described above provide a means for saving battery life in a communication system between first and second communication devices and can be summarized as follows: detecting whether the first communication device supports half-duplex capability; establishing a half-duplex audio link on a given channel when the second communication device determines that the first communication device supports half-duplex capability; and sending control messages between the devices that selectively enable/disable audio over the existing channel in both directions between the first and second communication devices. The step of sending control messages includes sending microphone and speaker on/off commands. Thus, communication device 102 is a device having half-duplex and full-duplex modes of audio operation that can automatically switch from full-duplex mode to half-duplex mode in response to establishing a link with a half-duplex communication device. One command can be used to turn the microphone on and the speaker off, and a second command can be used to turn the microphone off and the speaker on as described by technique 300. Alternatively first, second, third, and fourth commands can be used to turn the microphone on, the speaker off, the microphone off, and the speaker on as described by technique 400. A PTT button or a VOX signal at the first communication device instigates microphone/speaker on/off commands to be generated by the second communication device.

Accordingly, a communication system has been provided in which a first communication device has a speaker and microphone that provides full-duplex and half-duplex modes of audio operation for communicating with a second communication device having half-duplex or half and full-duplex capability.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A communication device having half-duplex and full-duplex modes of audio operation, the communication device automatically switching from full-duplex mode to half-duplex mode in response to establishing a link with a half-duplex communication device.

2. A communication system, comprising:
a first communication device having full-duplex and half-duplex capability;
a second communication device having half-duplex capability; and
the second communication device recognizing that the first communication device has half-duplex capability and automatically establishing a half-duplex audio link in response thereto.

3. The communication system of claim 2, wherein the first and second communication devices operate under a Bluetooth protocol.

4. The communication system of claim 3, wherein the first communication device comprises an earpiece.

5. The communication system of claim 4, wherein the second communication device is a two-way radio.

6. The communication system of claim 2, wherein the first communication device comprises an earpiece.

7. The communication system of claim 2, wherein the second communication device is a two-way radio.

8. A communication system, comprising:
a first communication device having a speaker and microphone and having half-duplex and full-duplex modes of audio operation;
a second communication device having half-duplex capability; and
the second communication device detecting the half-duplex capability of the first device and establishing a half-duplex audio link.

9. The communication system of claim 8, wherein the second communication device detects the half-duplex capability of the first communication device by a device capabilities interrogation protocol.

10. The communication system of claim 8, wherein the half-duplex audio link is controlled by AT commands.

11. The communication system of claim 10, wherein the half-duplex audio link is controlled by a first AT command that turns the microphone on and the speaker off, and a second AT command that turns the microphone off and the speaker on.

12. The communication system of claim 10, wherein the half-duplex audio link is controlled by:
a first AT command that turns the microphone on;
a second AT command that turns the speaker off;
a third AT command that turns the microphone off; and
a fourth AT command that turns the speaker on.

13. The communication system of claim 10, wherein the AT commands are generated by a PTT button on the first communication device.

14. The communication system of claim 10, wherein the AT commands are generated a Voice Activated Switch (VOX) at the first communication device.

15. A method of establishing an audio link between first and second communication devices, comprising:
establishing a link between the two communication devices;
detecting the lack or presence of audio at the first device using the second device;
establishing a half-duplex audio link by
a. issuing commands to turn a microphone on and a speaker off in response to detecting the presence of audio; and
b. issuing commands to turn the microphone off and the speaker on in response to a lack of audio

16. The method of claim 15, wherein the steps of issuing commands are generated by using a Push-To-Talk (PTT) button.

17. The method of claim 15, wherein a slave or master issues the commands upon detecting the lack or presence of audio.

18. A method of saving battery life in a communication system between first and second communication devices, comprising:
establishing a full-duplex audio link between the first and second communication devices, the second communication device being a half-duplex device;
detecting whether the first communication device supports half-duplex mode of operation;
establishing a half-duplex audio link on a given channel when the first communication device supports half-duplex operation; and
sending control messages between the devices that selectively enable/disable audio over the existing channel in both directions between the first and second communication devices.

19. The method of claim 18, wherein the step of sending control messages includes sending microphone and speaker on/off commands.

20. A communication system comprising:
first and second communication devices, the second communication device having interrogation capability to detect whether the first communication device supports half-duplex operation; and
the first and second communication devices establishing an audio link through the use of control messages that selectively enable/disable audio in both directions between the first and second communication devices.

21. The communication system of claim 20, wherein the control messages include microphone and speaker on/off commands.

22. The communication system of claim 20, further comprising:
a third communication device providing a remote trigger operation that sends a notification to the second communication device to issue commands to the third communication device to enter a half-duplex mode of operation.

23. The communication system of claim 22, wherein the third communication device detects a PTT or VOX inputs in order to provide the remote trigger to the second communication device.
